(19) United States
(12) Patent Application Publication
(10) Pub. No.: US 2010/0175605 A1
(43) Pub. Date: Jul. 15, 2010

(54) DEVICE AND METHOD FOR MOORING A VESSEL

(75) Inventor: Hans Rudolf Baartmans, Essen (BE)

Correspondence Address: FLIESLER MEYER LLP, 650 CALIFORNIA STREET, 14TH FLOOR, SAN FRANCISCO, CA, 94108, US

(73) Assignee: CONTINENTAL LABEL HOLDING B.V., Roosendaal (NL)

(21) Appl. No.: 12/617,546

(22) Filed: Nov. 12, 2009

(30) Foreign Application Priority Data
Nov. 12, 2008 (NL) 2002204

(51) Int. Cl. B63B 21/00; B63B 21/04; B23P 11/00

(52) U.S. Cl. 114/230.1; 29/428

(57) ABSTRACT

The present invention relates to a device for the attachment of a rope to a securing point by a person for mooring a vessel, comprising a support which is configured to releasably attach the rope to the securing point, and an elongate arm which is configured to be grasped at or near an end by the person and is configured such that the support can be attached at or near an opposite end so that attachment to the securing point can be carried out by the person at a distance. The elongate arm and the support attached thereto make it possible to displace a part of the rope at a distance and thus facilitate mooring.

The present invention relates to a device and a method for the attachment of a rope to a securing point by a person for mooring a vessel.

When fastening a vessel to one or more securing points, such as for example a bollard, cleat, ring and the like, which securing points are situated, for example, on another vessel or on shore, such as for example on the quayside, mooring post or jetty, it is important to secure a rope to the securing point as quickly as possible when the vessel is approaching the securing point and is only a few metres away from it, so that the vessel can be moored completely or partially by means of the rope. When the vessel has, for example, been partially moored, the vessel can more readily be manoeuvred and the vessel can then be moored without too many problems.

In this connection, it is important that a rope is attached to at least one of the securing points at an early stage. In general, the sooner the rope is attached, the easier and more controlled the mooring of the vessel will be, with the risk of incorrect manoeuvres and possible damage to the vessel or the quayside being low. However, there is a problem in that the person has to attach the rope to the securing point while there is still a distance of sonic metres between the securing point and the vessel. In order to ensure that the rope ends up near the securing point a number of operations have to be carried out. If, for example, on the quayside a bollard is present as the securing point, the person has to throw a rope loop around the bollard. To this end, he attaches one end of the rope to the vessel, holds the other end and then forms one or more loops and throws the rope in the direction of the bollard hoping that a loop will drop over the bollard in a single operation. If this is the case, the end of the rope held by the person is pulled and the vessel can be moored. However, in practice it is difficult to attach a rope to a bollard in this way, particularly in potentially stressful situations, for example in locks and the like where many vessels are gathered and there is little time or opportunity to moor the vessel. In another example, the securing point comprises a ring through which the rope has to be run. In such a situation, the vessel has to be brought very close to the securing point in order to give the person the opportunity to slide the rope through the ring manually. This may result in dangerous situations and, in many cases, the shipmaster is not able to moor the vessel without causing some damage.

Aids are known per se which intend to facilitate mooring of a vessel. U.S. Pat. No. 5,799,602, for example, describes a docking fork by means of which a mooring rope can be arranged around a securing object, such as a bollard, from a distance. The patent shows a U-shaped fork, wherein grooves are provided in the long sides of the U shape in which a loop of a rope is to be accommodated. The rope can thus be attached easily to a securing point, such as a bollard. An elongate arm can be attached to the fork via a screw thread. A drawback of the known docking fork is the fact that the respective rope end has to be configured as a fixed (permanent) loop and that the size of the loop cannot be adjusted to the circumstances. Furthermore, the dimensions of the fork determine around which type of securing point the rope loop can be fitted. If, for example, the U shape of the fork is smaller than the dimensions of the bollard, the rope can not be attached to this bollard. When the securing point is, for example, recessed slightly into the quay wall, the U-shaped fork also makes it difficult or even impossible from a practical point of view to attach the rope to this securing point.

Further drawbacks arc the fact that it is only possible to connect one rope between the securing point and the vessel (which makes the connection relatively insecure; with a double connection, the risk of rope rupture is smaller) and that it is difficult to detach the permanent rope loop from the securing point. If, for example, the rope is used in a lock or the vessel is situated in a waterway with varying water levels, the securing point is difficult or impossible to access from the vessel when the water level changes, thus making it difficult to detach the permanent rope loop from the securing point.

Therefore, it is often preferred not to fixedly secure the rope to the securing point, but to pass the rope around the securing point so as to be releasable. In other words, the rope is attached to the vessel, then passed around a securing point on the quayside (or on another vessel) and back to the vessel, where the returned rope portion is finally also attached to the vessel. If the vessel then has to be detached, it suffices to release the rope at one position in order to draw in the rope along the securing point. The securing point itself then no longer has to be directly accessible from the vessel in order to be able to release the rope from the securing point. The known device does not allow for this method of mooring and releasing the vessel.

It is therefore an object of the embodiments of the invention to provide a device and method for attaching a rope to a securing point by a person for mooring the vessel, in which the abovementioned drawbacks and/or other drawbacks from the prior art have been eliminated or at least reduced.

According to a first aspect, a device is provided for this purpose, which device comprises:
a support which is configured to connect the rope to the securing point;
an elongate arm which is configured to be grasped at or near a proximal end by the person and is also configured to fasten the support at or near an opposite distal end, so that the rope can be passed around the securing point from a distance,

wherein the support comprises a central support part, the central support part comprising groove-shaped parts arranged on either side thereof, in which groove-shaped parts rope portions of the rope can be placed in such a manner that a rope loop to be passed around the securing point is formed on the distal side of the support, and

wherein the groove-shaped parts are configured so as to allow the rope portions to be pulled through the groove-shaped parts in the longitudinal direction in order to enlarge or reduce the rope loop.

The elongate arm with the support attached thereto makes it possible to move a part of the rope (also referred to below as mooring line or mooring rope) from a relatively large distance (i.e. a distance of the same order of magnitude as the total length of the elongate arm with support) and take it to the vicinity of the securing point in a controlled manner. In addition, the respective part of the rope can then be attached to the securing point in a controlled manner, for example by passing all or part of the rope portion around the securing point (for example a bollard on the quayside or the upper end of a mooring post) or by passing the rope portion through an eyelet or ring from a distance. After the rope portion has thus been attached to the securing point, the rope can be pulled in (for example by pulling in that part of the rope which had not been attached to the vessel before) and/or secured to the vessel or elsewhere. This makes it possible to fasten the rope in an accurate and controlled manner to a securing point which is situated at a distance of a few metres and to then partially or completely moor the vessel.

It should be noted that the rope can be fastened directly to the securing point, as is the case when the rope is passed around a bollard. However, the rope can also be fastened indirectly to the securing point. It is, for example, possible to use a component for this purpose, such as the support defined herein, in which case the component with the rope which is attached thereto in a different manner is fastened to the securing point.

According to one embodiment, the arm is configured in such a manner that the length thereof can be varied, so that, depending on the (expected) distance to be bridged between the vessel and the securing point, the length of the arm can be adjusted. In a particularly advantageous embodiment, the arm can be configured to be telescopic, so that the length of the arm can be adjusted in a simple manner. As the arm can be adjusted in length, it can be reduced in size again after use and can thus easily be stored without taking up much space.

The length of the arm may or may not be variable. In its longest position, the total length is chosen such that, on the one hand, it can bridge a sufficiently large distance in order to make it possible to fasten the rope to the securing point in time (that is to say when the vessel is still relatively far away from the securing point) and, on the other hand, the device is still easy to handle. In the pleasure cruising sector (where vessels are up to approximately 15 m long), an arm having a total length of between 1 and 5 m is usually sufficient.

In embodiments of the invention, the support comprises two adjacent grooves, in each of which a rope portion can be accommodated. When the rope portions have been placed in the grooves, it is possible to form a rope loop between the rope portions. The rope loop can in this case have dimensions which are such that the rope, more specifically that part of the rope between said rope portions, can be passed around the securing point completely or partially. When the rope has been passed around the securing point, the rope can be tightened directly or the support can be removed first. In certain embodiments, the grooves are configured in such a manner that the respective rope portions can be removed therefrom. The rope portions may, for example, be fitted in the holes in a more or less clamping fashion. The clamping force then ensures that the ropes rest in the grooves as much as possible. When the rope portions of the support have to be removed, the person detaches the rope portions from the support by overcoming said clamping force. Each of the grooves may, for example, comprise an elongate slot at the top side. In this case, the slot is configured (with regard to positioning, shape and dimensions) to make it possible for the rope to be arranged in the groove via the slot and to remove the rope from the support via the reverse route.

The groove-shaped parts preferably extend next to one another with an intermediate space between one and four times the groove diameter, so that both rope portions which have to be connected to the vessel are close to the arm, which improves the ease of handling of the device.

According to one embodiment of the invention, each of the groove-shaped parts comprises a proximal opening provided in a first side of the support and a distal opening provided in a second side of the support, along which the rope portions can be displaced in the longitudinal direction. This arrangement improves the ease with which the rope can be displaced along the groove-shaped pans in the longitudinal direction, for example in order to make the rope loop larger or smaller. For similar reasons, the groove-shaped parts may be formed by uninterrupted slots extending in the support from the proximal to the distal side. These may optionally be slightly curved, but in other embodiments they are straight in order to ensure that a displacement in the longitudinal direction is accompanied by relatively little friction force.

According to a further embodiment, the grooves comprise one or more resilient parts for clamping ropes of different diameters in the respective groove. The resilient pails may, for example, be formed by one of the longitudinal edges (or both longitudinal edges) on either side of the abovementioned slot. The resilient parts ensure that the rope is pushed into the respective groove. In particular, the resilient parts are configured to ensure that ropes of different diameters remain pushed into the groove. The resilient parts may, for example, be configured to clamp ropes having a diameter of between 1 cm and 3 cm.

In embodiments of the invention, the grooves extend obliquely with respect to one another. More particularly, the grooves are arranged such that the distance between them increases as the distance to the arm increases. In a specific embodiment, said distance between them increases by, for example, approximately 20%. As a result thereof, the rope is forced to extend more in order to form a loop, which makes it even easier to arrange the rope around the securing point.

In embodiments of the invention, the support comprises a first securing member for securing the support to the securing point and a second securing member for securing the rope to the support, so that the rope can be fastened to the securing point indirectly. In one specific embodiment, the first securing member comprises a hook or similar securing element. The hook may, for example, be inserted into an annular securing point or the like and be fitted thereto.

In a further embodiment, the elongate arm is provided with a first support by means of which, for example, it is possible to connect to the quayside directly and a second support which can releasably be fitted to the first support and by means of which, for example, it is possible to connect to the quayside indirectly.

According to another aspect, an assembly is provided comprising a device as defined herein and a rope for mooring the vessel to the securing point.

According to a further aspect of the invention, a method of the kind mentioned in the preamble is provided, which method comprises:
arranging a rope on the support;
grasping one end of the arm and guiding the other end of the arm which is provided with the support over a distance to the securing point;
securing the rope and/or the support to the securing point;
removing the arm.

The method also comprises increasing or reducing the length of the arm in order to bridge the distance between the vessel and the securing point. In this case, it is possible to attach the rope to the support first and then to adjust the length of the arm (usually resulting in an increase). However, it is also possible to extend the arm first and only then to arrange the rope on the support. Subsequently, the arm is held overboard in order to bridge the distance between the vessel and the securing point.

Preferably, the method comprises:
keeping a first part and a second part of the rope on hoard the vessel;
arranging the rope between the first and second rope portion in the support for forming a rope loop at the location of the support;
moving the rope loop to the securing point;
passing the rope loop around the securing point;
removing the rope from the support;
pulling in the arm with the support attached thereto;
securing the first part and second rope portion to the vessel.

In addition or alternatively, the method may comprise:
keeping a first part of the rope on board the vessel;
securing a second part of the rope to the second securing member of the support;
moving the support to the securing point and securing the support to the securing point using the first securing member;
pulling in the arm:
securing the rope to the vessel.

Further advantages, characteristic features and details of the present invention will be explained in more detail by means of the following description of some preferred embodiments thereof. In the description, reference is made to the attached figures, in which:

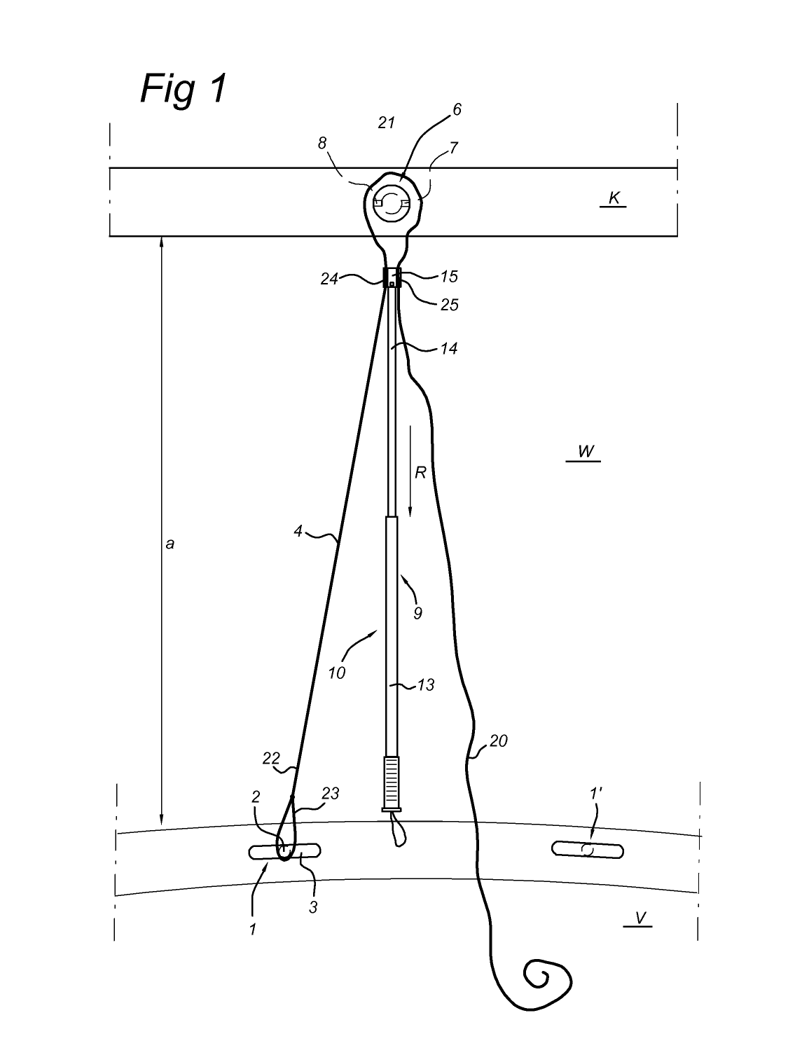

FIG. 1 shows a diagrammatic top view top view of a part of a vessel and a securing point on the quayside, in which an embodiment of the invention is used;

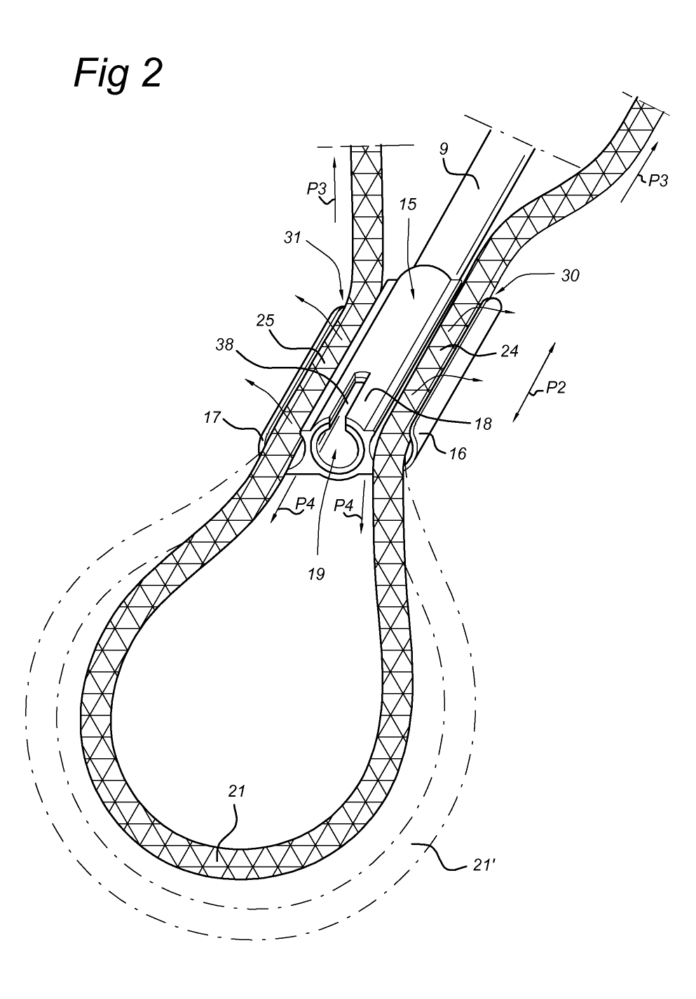

FIG. 2 shows a detailed view at the location of the support of the embodiment illustrated in FIG. 1;

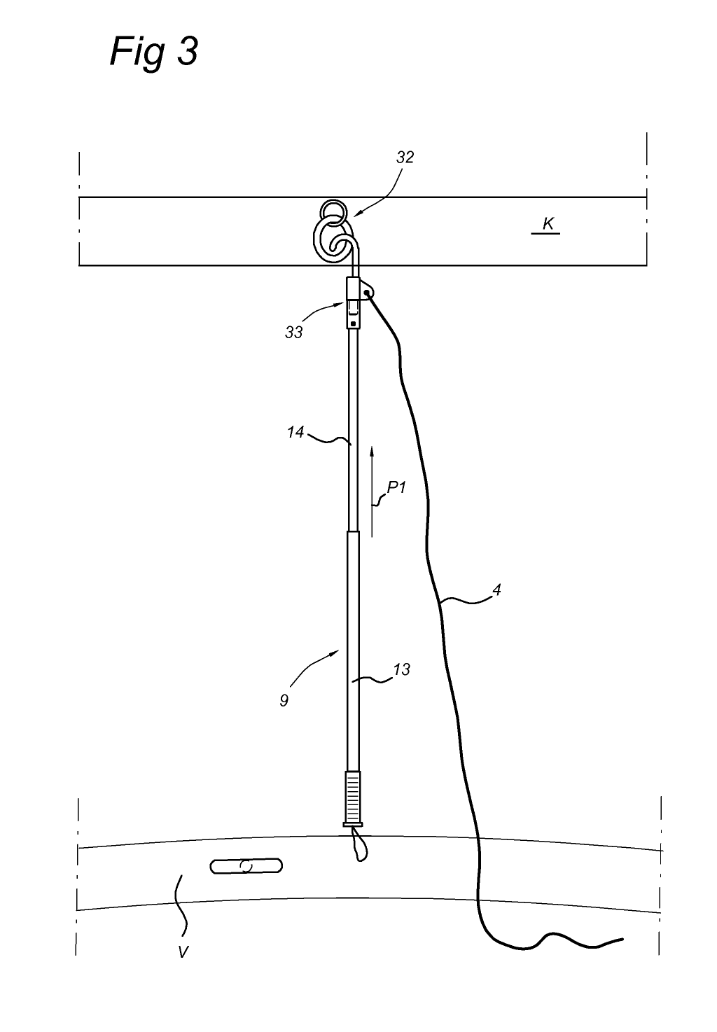

FIG. 3 shows a top view of a part of a vessel and a securing point of a different type situated on the quayside, in which a second embodiment according to the invention is used;

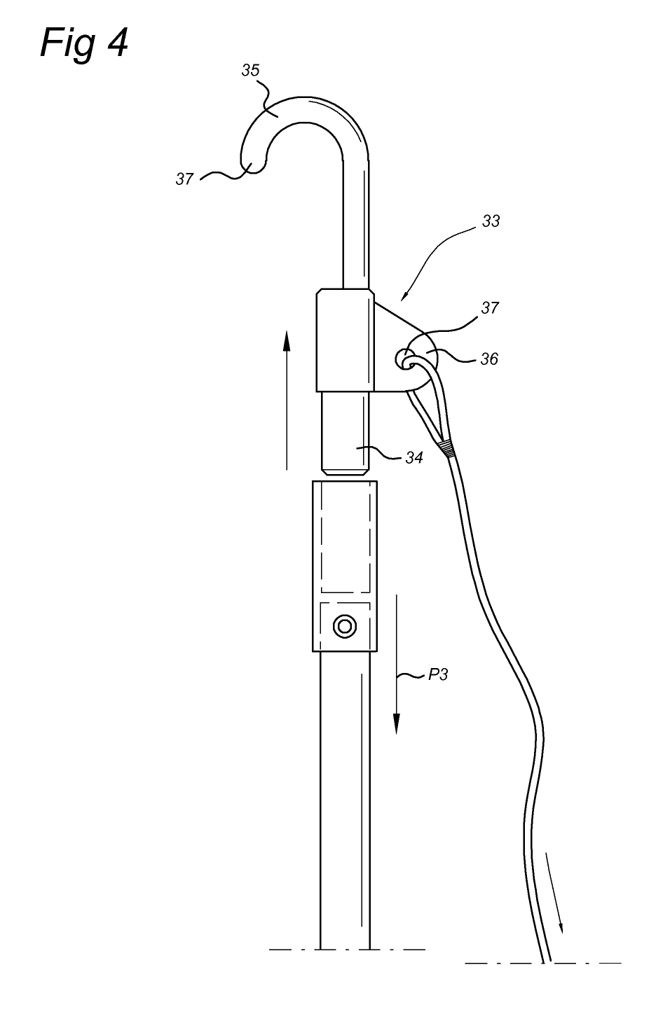

FIG. 4 shows a more detailed view of the second embodiment; and

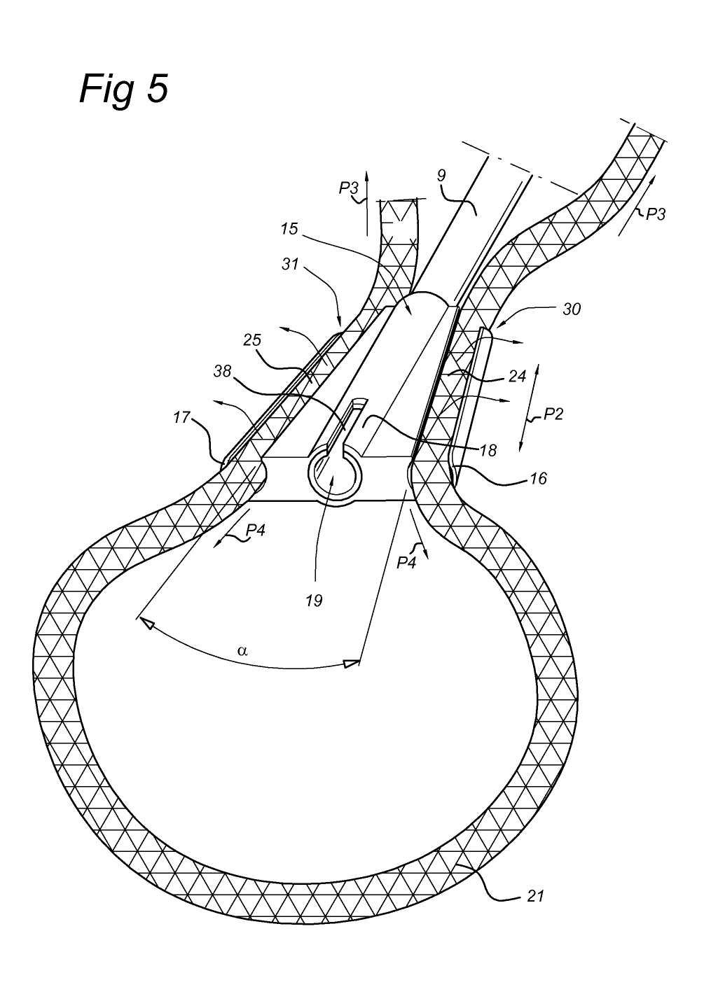

FIG. 5 shows a view of a further embodiment of the invention.

A first embodiment of the invention is explained in more detail with reference to FIGS. 1 and 2. FIG. 1 shows a diagrammatic view of a part of a vessel V which travels on a waterway W at a short distance (a) from a quay wall K. The quay wall is provided with securing points (of which only one securing point is shown in FIG. 1) to which the vessel V can be moored. In the illustrated embodiment, the securing point 6 is a bollard consisting of an upright part 7 fixed in the quay and two projections 8 protruding at right angles thereto. The object is to moor the vessel on at least the illustrated bollard 6 using a ship rope. The aim is for this ship rope to have already been passed around the bollard 6 before the vessel comes close to the quay. In practice, the distance (a) between the side of the vessel and the quay at which the ship rope can be arranged around the bollard 6 is between 1 m and 5 m, depending on the speed of the ship and on the size thereof, although a larger distance may also be possible. The distance is preferably as large as possible in order to have as much time as possible to attach the rope to the bollard 6 and the vessel, but is limited by, inter alia, the ease of handling of the auxiliary device to be described below.

The vessel itself is also provided with one or more securing points. In the illustrated exemplary embodiment, the vessel comprises a first bollard 1 and a second bollard 1′, each of which are composed of an upright part 2 and two horizontal projections 3 provided at right angles thereto. When the vessel approaches the quay and the distance (a) thus becomes smaller, a person usually throws the rope like a lasso in the direction of the bollard 6 provided on the quay, after he has attached a rope or mooring rope 4 to one of the bollards of the vessel, hoping that a part 21 of the rope will end up around the bollard 6 and become hooked thereto. In this case, he holds the loose part 20 of the rope 4, so that he can pull on the loose part 20 in order to force the vessel in the direction of the quay once said rope portion 21 has been arranged around the bollard 6 on the quay. When the vessel has been positioned correctly with respect to the quay, the rope 4 can be attached to the quay and/or the vessel itself, for example by securing the loose rope portion to the bollard 1′.

Depending on the proficiency of the person throwing the rope 4, the chances of succeeding in dropping the rope 4 around the bollard on the quay after one or only a few attempts are in many cases fairly slim. However, if the vessel is not moored in time, it is difficult to manoeuvre the vessel in such a manner that the vessel is not damaged, for example by the vessel V hitting the quay.

However, according to the invention the person can, for example, pass the rope 4 around the bollard 6 at a relatively large distance by means of the auxiliary device 10 illustrated in FIGS. 1 and 2 in a quick and simple manner, so that there is more time to position the vessel correctly with respect to the quay and optionally moor the latter when it approaches the quay. To this end, the person first attaches the first end 21 of the rope 4 to the bollard 1 on the vessel V, for example by passing a rope eye 23 provided on the rope 4 around the bollard 1. Then, he or she attaches a rope portion 24 and a rope portion 25 of the rope to the auxiliary device 10. Auxiliary device 10 comprises an elongate arm 9 which, in the illustrated embodiment, is of telescopic design. This means that arm parts 13, 14 are configured to be pulled in or pulled out with respect to one another (direction P₁, FIG. 1). At a first end of the arm 9, a handle 11 is provided by means of which the arm can be grasped by the person. At the opposite end of the arm 9, a support 15 is provided. The support 15 comprises a central part 18 and two substantially groove-shaped parts 16 and 17 provided alongside the central part 18. The central part 18 is provided with a through-opening 19 which is configured such that the end of the arm 9 can be pushed into the opening in order to produce a releasable coupling between the support 15 and the arm 9.

Each of the grooves 16,17 has a substantially circular or at least rounded cross section and is provided with an elongate slot 30, 31 on one longitudinal side. Slot 30, 31 is dimensioned with respect to the rope 4 in such a manner that the rope 4 can be arranged in the respective groove via the respective slot 30, 31 and/or can be removed therefrom by overcoming a certain friction force. This means that, when no excessive force is exerted thereon, the rope 4 will remain in the grooves and can be displaced therein in the longitudinal direction (direction P₂), while, when a relatively large force is exerted thereon at right angles to the longitudinal direction (larger than the friction force between the rope and the groove edges), the rope can be removed front the support.

As is illustrated in FIG. 2, the rope 4 is arranged in the two grooves 16, 17 in such a manner that a loop-shaped part 21, also referred to as rope loop, is formed. The size of the rope loop 21 is such that it can easily be passed around the bollard 6 on the quay. When the person has fastened the loose end 22 of the rope 4 to the bollard 1, has secured the rope 4 to the support 15 in such a manner that a rope loop 21 is produced and has extended the telescopic arms 13, 14, he or she has a rope loop 21 which can be passed around the bollard 6 across a distance which is equal to the length of auxiliary device 10. Once the rope loop 21 has been arranged around the bollard, he or she pulls the support 15 away from both ropes via the arm 9 so that the auxiliary device is on hoard again. Thereafter, the person can pull the vessel in the direction of the quay by pulling the opposite end 20 of the rope and, if desired, moor it on one of the other securing points on the quayside and/or on the vessel, if desired.

A further advantage of the structure is the fact that, for example, when the bollard is larger than originally assumed and consequently a larger rope loop 21 is required to be able to attach the rope to the bollard, the rope loop can be made larger (as is indicated, for example, by dashed lines in FIG. 2) by first hooking it behind an object somehow, for example behind part of the bollard, and by then slightly retracting the arm 9. The person thus pulls at least one of the rope portions along the support (direction P₄, FIG. 2), resulting in the rope loop being larger.

In some cases, the securing point on the quay is of a design which differs so much that it is not possible to arrange a loop around it. When, for example, the securing point is configured as a ring 32 which is attached to the quay K, the rope 4 has to be attached in a different way. In those cases, the ship usually comes close to the quay and an end, for example end 20, of the rope is passed through the eye 32 by hand, after which the rope can be tightened. However, this means that the vessel has to come very close to the quay, with all the risks this entails. In such cases, the embodiment of FIGS. 1 and 2 provides for fitting a second support 33 on the support 15 which is situated at the end of the arm 9. To this end, support 33 is provided with a projection 34 which is formed in such a way that it fits inside the hole 19 of the first support 15. The second support 33 can thus be fitted readily to the first support 15 by sliding the projection 34 into the hole 19. The support 33 is furthermore provided with a hook-shaped component or book 35. The hook 35 is shaped in such a manner that it can be fitted around the eye 32, as is illustrated in FIG. 3. Finally, support 33 is provided with a flange 36 which comprises an opening 37. In the opening 37, the rope eye 23 is arranged which is provided on the end 22 of the rope. FIG. 3 shows that the rope 4 is connected to the securing point 32 indirectly, that is to say via the hook 33.

The central part 18 of the support 15 may optionally be provided with a hole 38 which extends in the longitudinal direction. This hole has a width which is such that the end of the flange 36 can be pushed off the hook (FIG. 4), so that the hook can no longer rotate about its longitudinal axis in the attached state. This prevents the hook from rotating when a person tries to attach the hook to a securing point, since this could make it more difficult to attach the hook.

When the vessel now approaches the quay, the hook 35 is attached to the eye 32, that is to say that the end 37 of the hook 35 is inserted in the ring 32. Thereafter, the rope 4 is pulled in from the vessel. As the end 22 of the rope 4 was attached to the second support 33, an indirect connection has been produced between the rope 4 and the securing point 32, namely a connection via the second support 33. The first support 15 as well as the arm 9 attached thereto can be removed in a simple manner by pushing the first support 15 away from the second support 33.

Many alternatives of the illustrated embodiments are possible. The main point is that use is made of an elongate arm in order to guide the line in a manner which can be controlled in a simple way and across a relatively large distance (a) to the securing point so that the line can be secured directly or indirectly with a relatively large degree of precision to the securing point or can at least be passed around it. In some embodiments the arm has a constant length, whereas in other embodiments the arm can he extended. In the last-mentioned embodiments, a relatively large distance can be bridged, while the aid can be stored in a relatively compact manner after use.

Preferably, the arm 9 is made of aluminium. One advantage of the use of aluminium is that the arm can be of a relatively lightweight design, making the arm easy to handle, yet also sufficiently stiff. The support 15 and/or support 33 arc preferably made of plastic or pouring rubber.

In a further embodiment, as is illustrated, for example, in FIG. 5, the support 15 is configured such that the grooves 30, 31 extend slightly obliquely with respect to one another. In the illustrated embodiment, the grooves on the side of the arm 9 are relatively close together, whereas the grooves on the opposite side of the support are situated further apart. The grooves 16, 17 are therefore arranged in a diverging position. This leads to the situation where the rope loop which extends distally from the support is held slightly open, so that the rope loop 21 can more readily be passed around a securing point.

When, for example, the mutual distance between the grooves increases by approximately 10-50% or 15-30% from the side where the arm 9 is attached to the support up to the free end of the support, the likelihood that a loop which has been formed in the rope indeed maintains the original loop shape (and therefore does not begin to twist) is significantly increased. It has been found that when the proximal end parts of the grooves extend obliquely at an angle (α) with respect to one another (FIG. 5) of at most 60 degrees, the rope loop remains particularly well in the open position. This means that the chances of securing the loop around the securing point are very high.

The present invention is not limited to the embodiments thereof which arc described above. The rights sought are mainly defined by the attached claims, which allow for numerous adaptations and modifications.

1. Device for the attachment of a rope to a securing point by a person for mooring a vessel, comprising:
a support which is configured to connect the rope to the securing point;
an elongate arm which is configured to be grasped at or near a proximal end by the person and is also configured to fasten the support to or near an opposite distal end, so that the rope can be passed around the securing point from a distance,
wherein the support comprises a central support part, the central support part comprising groove-shaped parts arranged on either side thereof, in which groove-shaped parts rope portions of the rope can be placed in such a manner that a rope loop to be passed around the securing point is formed on the distal side of the support, and wherein the groove-shaped pails are configured so as to allow the rope portions to be pulled through the groove-shaped parts in the longitudinal direction in order to enlarge or reduce the rope loop.

2. Device according to claim 1, wherein each of the groove-shaped parts has a proximal opening provided in a first side of the support and a distal opening provided in a second side of the support, along which the rope portions can be displaced in the longitudinal direction.

3. Device according to claim 1, wherein the groove-shaped parts extend next to one another with an intermediate space of between one and four times the groove diameter.

4. Device according to claim 1, wherein the groove-shaped parts extend in an at least partially diverging manner with respect to one another from the proximal side to the distal side of the support.

5. Device according to claim 4, wherein at least the distal pails of the groove-shaped parts extend obliquely with respect to one another at an angle of at most 60 degrees.

6. Device according to claim 1, wherein the two rope portions arranged in the groove-shaped parts, in a position where the rope loop is passed around the securing point, can be removed from the groove-shaped parts via respective elongate slots provided on the upper side of a groove-shaped part.

7. Device according to claim 1, wherein the groove-shaped parts comprise one or more resilient parts for clamping ropes of different diameters in the respective groove.

8. Device according to claim 7, wherein the clamping force in the longitudinal direction is smaller than the clamping force in the transverse direction.

9. Device according to claim 1, wherein the groove-shaped parts are formed by uninterrupted slots extending in the support from the proximal to the distal side.

10. Device according to claim 1, in which the support comprises a first securing member for securing the support to the securing point and a second securing member for securing the rope to the support.

11. Device according to claim 10, comprising:
a first support which is releasably attached to the arm and provided with the groove-shaped parts for securing a rope; and
a second support which is releasably attached to the first support and provided with the securing members according to claim 10.

12. Device according to claim 11, wherein the first securing member comprises a hook.

13. Device according to claim 12, wherein the support comprises a slot extending in the longitudinal direction and the hook comprises a projection which can be pushed into the slot and extends in the longitudinal direction in order to prevent the hook and the support twisting with respect to one another.

14. Assembly of a device according to one of the preceding claims and a rope for mooring the vessel to the securing point.

15. Method for the attachment of a rope to a securing point by a person for mooring a vessel, comprising:
arranging a rope on the support of a device according to one of the preceding claims;
grasping one end of the arm and guiding the other end of the arm which is provided with the support over a distance to the securing point;
securing the rope and/or the support to the securing point;
removing the arm.
